(19) United States
(12) Patent Application Publication
(10) Pub. No.: US 2009/0063352 A1
(43) Pub. Date: Mar. 5, 2009

(54) METHODS AND SYSTEMS FOR MONETARY EXCHANGE AND TRANSFER

(76) Inventor: Lance Kaufman, Scottsdale, AZ (US)

Correspondence Address: THE NOBLITT GROUP, PLLC, 4800 NORTH SCOTTSDALE ROAD, SUITE 6000, SCOTTSDALE, AZ, 85251, US

(21) Appl. No.: 12/202,081

(22) Filed: Aug. 29, 2008

Related U.S. Application Data
(60) Provisional application No. 60/966,590, filed on Aug. 29, 2007.
(60) Provisional application No. 61/009,802, filed on Jan. 2, 2008.
(60) Provisional application No. 61/011,969, filed on Jan. 23, 2008.

(51) Int. Cl. H04L 9/00; G06Q 40/00

(52) U.S. Cl. 705/65; 705/39

(57) ABSTRACT

A system for monetary exchange and transfer comprises a centralized location, wherein the centralized location comprises at least a first account at the centralized location comprising first funds for a first user and a second account at the centralized location comprising second funds for a second user. The system may further comprise a first device associated with the first account configured to electronically store by the first device an accounting of the first funds, a second device associated with the second account configured to electronically store by the second device an accounting of the second funds, and an electronic transfer system configured to transfer at least a portion of the first funds from the first device directly to the second device. The system may further comprise a receiver system configured to receive at least a portion of the first funds by the second device directly from the first device, a first device accounting reconciliation system configured to reconcile the accounting of the first funds by the first device, and a second device accounting reconciliation system configured to reconcile the accounting of the second funds by the second device.

### CROSS-REFERENCES TO RELATED APPLICATIONS

This application claims the benefit of U.S. Provisional Patent Application No. 60/966,590 filed Aug. 29, 2007, U.S. Provisional Patent Application No. 61/009,802 filed Jan. 2, 2008, and U.S. Provisional Patent Application No. 61/011,969 filed Jan. 23, 2008, and incorporates the disclosure of each application by reference.

### BACKGROUND

In the current monetary transaction environment, cash is becoming less and less desirable as a preferred medium to settle debts and credits between entities. Moreover, numerous and often excessive fees charged by financial card companies are undesirable by users and merchants, and with the difficulty of executing several transactions among numerous users and entities without realizing the numerous and excessive fees, such cards are not a feasible option.

### BRIEF DESCRIPTION OF THE DRAWINGS

A more complete understanding of the methods and systems for monetary exchange and transfer may be derived by referring to the detailed description and claims when considered in connection with the following illustrative figures. In the following figures, like reference numbers refer to similar elements and steps throughout the figures.

FIG. 1 representatively illustrates a monetary transfer and exchange system;

FIG. 2 representatively illustrates an embodiment of the monetary transfer and exchange system;

FIG. 3 representatively illustrates an embodiment of a device for the monetary transfer and exchange system;

FIG. 4 representatively illustrates a continuing embodiment of the device for the monetary transfer and exchange system;

FIG. 5 representatively illustrates another embodiment of a device for the monetary transfer and exchange system;

FIG. 6 representatively illustrates another embodiment of a device for the monetary transfer and exchange system;

FIG. 7 representatively illustrates another embodiment of devices for the monetary transfer and exchange system;

FIG. 8 representatively illustrates another embodiment of a device for the monetary transfer and exchange system;

FIG. 9 representatively illustrates another embodiment of devices for the monetary transfer and exchange system;

FIG. 10 representatively illustrates an embodiment of a transfer according to the monetary transfer and exchange system;

FIG. 11 representatively illustrates an embodiment of a ledger according to the monetary transfer and exchange system;

FIG. 12 representatively illustrates an embodiment of funds according to the monetary transfer and exchange system;

FIG. 13 representatively illustrates another embodiment of a monetary transfer and exchange system;

FIG. 14 representatively illustrates an embodiment of interrelated users according to a monetary transfer and exchange system;

FIG. 15 representatively illustrates an embodiment of a method for a monetary transfer and exchange system;

FIG. 16 representatively illustrates a continuing embodiment of the method for the monetary transfer and exchange system;

FIG. 17 representatively illustrates a continuing embodiment of the method for the monetary transfer and exchange system;

FIG. 18 representatively illustrates an embodiment of a method for a monetary transfer and exchange system; and

FIG. 19 representatively illustrates a continuing embodiment of the method for the monetary transfer and exchange system.

Elements and steps in the figures are illustrated for simplicity and clarity and have not necessarily been rendered according to any particular sequence. For example, steps that may be performed concurrently or in different order are illustrated in the figures to help to improve understanding of embodiments of the methods and systems for monetary exchange and transfer.

### DETAILED DESCRIPTION

Methods for monetary exchange and transfer may be described in terms of functional block components and various processing steps. Such functional blocks may be realized by any number of components configured to perform the specified functions and achieve the various results. Moreover, systems for monetary exchange and transfer may be described in terms of system elements and components. Such system elements and components may be realized by any number of elements and components configured to perform their specified operation, and other equivalent components are contemplated by this disclosure whether or not specifically described.

In an embodiment, a transaction system comprises a centralized location comprising at least a first account comprising first funds for a first user, and a second account comprising second funds for a second user. The transaction system further comprises a first device associated with the first account configured to electronically store an accounting of the first funds, a second device associated with the second account configured to electronically store an accounting of the second funds, an electronic transfer system configured to transfer at least a portion of the first funds from the first device directly to the second device, a receiver system configured to receive at least a portion of the first funds by the second device, a first device accounting reconciliation system configured to reconcile the accounting of the first funds by the first device, and a second device accounting reconciliation system configured to reconcile the accounting of the second funds by the second device.

The transaction system may further comprise the first device to be a secured first key fob, and the second device to be a secured second key fob, wherein the secured first and secured second key fobs may comprise biometric security. The transaction system may further comprise the first and second device to comprise internal memory, display systems, and/or near field communication systems. Moreover, the transaction system comprises the first funds for the first account to originate from at least one of a bank account, a checking account, a savings account, cash, a credit card, a debit card, a rewards card, a merchant card, and an incentive program.

In another embodiment, a transaction method comprises providing a centralized location, wherein the centralized location comprises at least a first account comprising first funds for a first user, and a second account comprising second funds for a second user. The transaction method further comprises providing a first securable device associated with the first account, storing an accounting of the first funds by the first device, providing a second securable device associated with the second account, storing an accounting of the second funds by the second device, transferring by an electronic signal at least a portion of the first funds from the first device directly to the second device, reconciling the accounting of the first funds by the first device, and reconciling the accounting of the second funds by the second device.

The transaction method further comprises transferring by an electronic signal at least a portion of the first funds from the first securable device directly to the second securable device, which may further comprise unsecuring the first securable device, unsecuring the second securable device, encrypting the electronic signal by the first securable device, transferring the electronic signal from the first securable device to the second securable device, decrypting the electronic signal by the second securable device, confirming the transfer from the first securable device to the second securable device by the first securable device, and confirming the transfer to the second securable device from the first securable device by the second securable device.

The transaction method may further comprise reconciling the accounting of the first funds by the first securable device with the first account at the centralized location, reconciling the accounting of the second funds by the second securable device with the second account at the centralized location, and electronically storing an accounting history of the electronic transfer by the first securable device and by the second securable device.

In another embodiment of a transaction method, the transaction method comprises providing a centralized location to maintain a plurality of accounts, wherein a first account at the centralized location comprises first funds from a first user, and a second account at the centralized location comprises the second account for a merchant. This embodiment further comprises providing a first device that may be electronically secured and associated with the first account, electronically storing an accounting of the first funds by the first device, providing a merchant receiver, electronically transferring directly from the first device to the merchant receiver at least a portion of the first funds, electronically transferring from the merchant receiver to the second account for the merchant the at least a portion of the first funds, reconciling the accounting of the first funds by the first device, and reconciling the second account for the merchant.

This embodiment of a transaction method may further comprise transferring at least a portion of the first funds from the first device to the merchant receiver. The transaction method may further comprises unsecuring the first device, encrypting the electronic transfer between the first device and the merchant receiver, confirming the electronic transfer from the first device to the merchant receiver by the first device, and confirming the electronic transfer to the merchant receiver from the first device by the merchant receiver.

This embodiment may further comprise reconciling the accounting of the first funds by the first device with the first account at the centralized location, and/or electronically storing an accounting history of the electronic transfer by the first device.

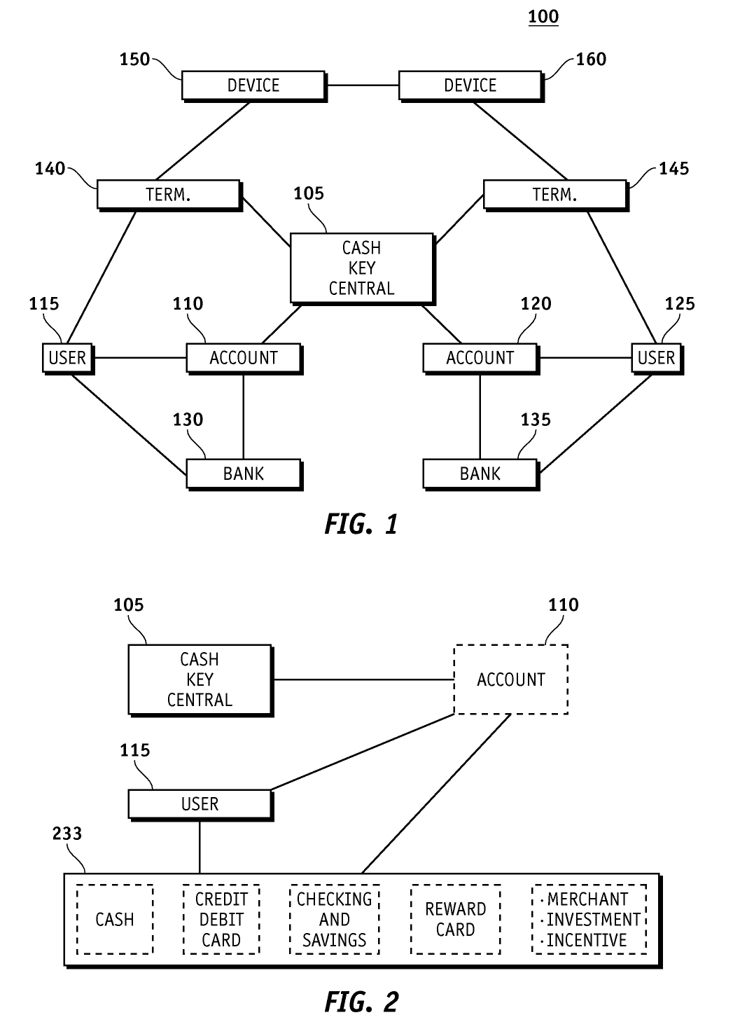

Turning now to the figures, and with reference to FIG. 1, an embodiment of a monetary exchange and transfer system 100 comprises a centralized location 105, comprising at least a first account 110 for a first user 115, and a second account 120 for a second user 125. A first bank 130 may be associated with first user 115 and first account 110, and a second bank 135 may be associated with second account 120 and second user 125. Transfer system 100 may further comprise a first terminal 140 associated with first user 115, and a second terminal associated with second user 125. Transfer system 100 may also comprise a first device 150 associated with first user 115, and a second device 160 associated with second user 125. The embodiments described with reference to first and second elements are not limited specifically to such first and second elements, but rather any number of third, fourth, fifth, etc., elements may benefit from the systems and methods described.

The centralized location 105 comprises an entity configured to hold, maintain, and/or manage various accounts, as well as carry out other administrative duties. Centralized location 105 may comprise a typical brick and mortar physical entity, or may comprise an electronic entity (such as an on-line entity), and/or a combination of both. As noted, centralized location 105 may hold, maintain, and/or manage various accounts. For example, first user 115 may have centralized location 105 hold, maintain, and/or manage first account 110, and second user 125 may have centralized location 105 hold, maintain, an/or manage second account 120.

The system 100 may further comprise a first user 115 and the first user 115 may deposit, debit, credit, and/or transfer funds within or between the first bank 130 and the first account 110 at the centralized location 105. Similarly, second user 125 may deposit, debit, credit, and/or transfer funds within or between second bank 135 and second account 120 at centralized location 105. With momentary reference to FIG. 2, funds provided to the various accounts, such as accounts 110 and 120 at centralized location 105, may not necessarily originate from a bank, such as banks 130 and 135, but rather, may originate from other fund sources. For example, funds 233 may be provided directly to account 110 for user 115. Funds 233 may comprise cash, a credit card, a debit card, a checking and/or savings account, an investment account, a merchant account, a rewards card, a gift card, as part of an incentive program, and the like, and may originate from the entities from which such other fund sources derive.

The system 100 may comprise a first terminal 140 and a second terminal 145. First terminal 140 provides a system for first user 115 to communicate with first account 110, centralized location 105, first bank 130, and/or first device 150. Similarly, second terminal 145 provides a system for second user 125 to communicate with second account 120, centralized location 105, second bank 135, and/or second device 160. First terminal 140 and second terminal 145 generally comprise personal computer systems, but may comprise any suitable systems that allow a user to carry out the various communications. Other examples of terminals may comprise an IPOD®, an IPHONE®, a cell phone, a PDA, a BlackBerry®, an mp3 player, a money card phone, and the like.

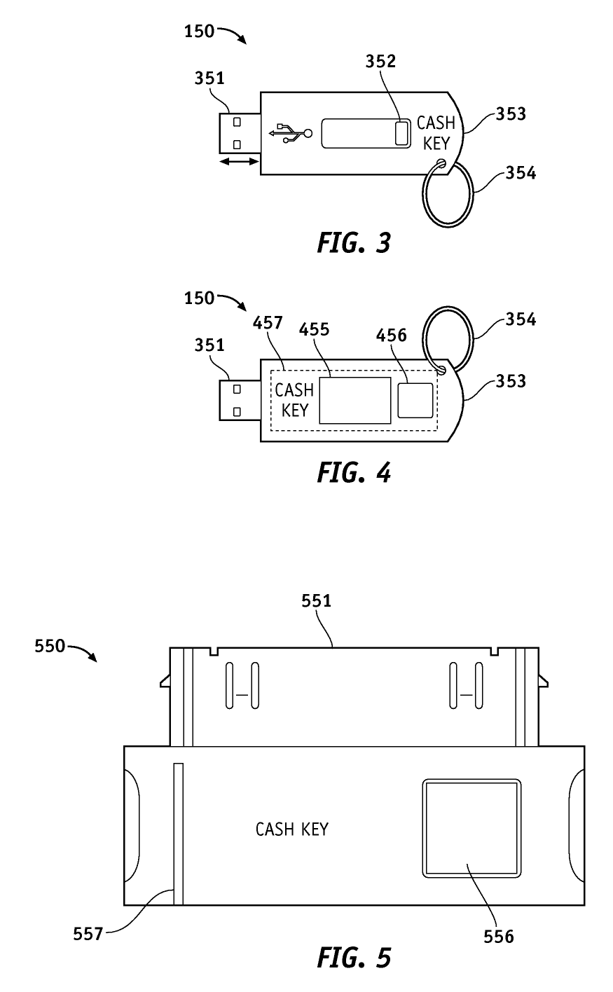

The embodiment of system 100 further comprises devices, such as first device 150 and second device 160. With reference to FIG. 3, one side of device 150 is shown. Among various embodiments, device 150 resembles a key fob type device and in many respects comprises the functions of a key fob type device; however, device 150 comprises several more elements. Moreover, device 150 may comprise other configurations, for example, device 150 may comprise a card type device, a pen type device, etc.

In an embodiment, device 150 comprises an electronic connection element 351, wherein electronic connection element 351 may comprise a USB element 351 that allows device 150 to plug into and communicate with a terminal, such as first terminal 140, having a cooperative USB port. Device 150 may also comprise other connection elements that allow device 150 to communicate with a terminal. Device 150 may further comprise a storing mechanism, such as slide retractor 352, which may be suitably coupled to USB element 351. Slide retractor 352 may allow a user to retract USB element 351 within a device body 353 to protect USB element 351 when not in use. Moreover, slide retractor 352 may comprise a locking mechanism to prevent slide retractor 352 from operating during use. Other retractable, storing and/or locking mechanisms are also contemplated by this disclosure, for example, spring type retractors, folding mechanisms, covers, caps, and the like. Device 150 may also comprise a securing mechanism, such as key ring 354. Key ring 354 may secure device 150 to a key ring, a belt loop, a purse strap, and the like. Moreover, securing mechanisms other than key ring 354 may be used, such as straps, clips, snaps, buttons, hook and loop mechanisms, and the like.

With reference to FIG. 4, the opposite side of device 150 is shown. Among various embodiments, device 150 may further comprise a display mechanism 455, an input mechanism 456, and internal circuitry 457. Display mechanism 455 comprises any visual display or output mechanism to display and/or provide data and/or information for first user 115 by device 150. Such display mechanisms may comprise a touch screen, an LCD screen, a plasma screen, a CRT screen, LED's, rectifiers, and the like.

Continuing with this embodiment, input mechanism 456 provides first user 115 the ability to input and/or manipulate information for device 150. Input mechanisms may comprise any appropriate input elements, such as a keyboard, a key pad, a touch screen, a biometric mechanism, a mouse, a keyboard, a voice recognition system, USB ports, a magnetic card reader, an eye retina scanner, a video recognition system, and any other electronic system that may allow a user to input and/or manipulate data for device 150.

As shown in FIG. 4, input mechanism 456 may comprise a biometric security mechanism, such as a finger print identifier. In such an embodiment, biometric security mechanism 456 may be configured to recognize the fingerprint pattern from a finger of first user 115. Alternatively, biometric security mechanism 456 may recognize any one of the fingers of first user 115, such that any finger may be used to operate biometric security mechanism 456. Biometric security mechanism 456 may also comprise other security mechanisms, such as voice recognition systems, eye retina scanners, etc.

In another embodiment, biometric security mechanism 456 may also double as an input element for first device 150. For example, each finger of first user may correspond to a particular number. In one example, a thumb from user 115 may correspond to zero, the thumb tapped twice in quick sequence may correspond to the number one, the index finger from user 115 may correspond to the number two, and the index finger tapped twice in quick sequence may correspond to the number three, and so on with the remaining numbers and fingers from user 115. In this manner, user 115 may securely access and operate first device 150, and user 115 may also use biometric security mechanism 456 as an input element.

Continuing with this embodiment, first device 150 comprises internal circuitry 457. Internal circuitry 457 may comprise, a transmitter, a receiver, transceivers, IC chips, processors, memory, and any other electronic components useful to carry out the functions of a monetary exchange and transfer. In an embodiment at least a portion of internal circuitry 457 may be configured to transfer an electronic signal and/or receive an electronic signal. In another embodiment, at least a portion of internal circuitry 457 may also comprise software to carry out the various functions of device 150, for example, software to encrypt a transferred signal and/or decrypt a received signal, or accounting software, etc.

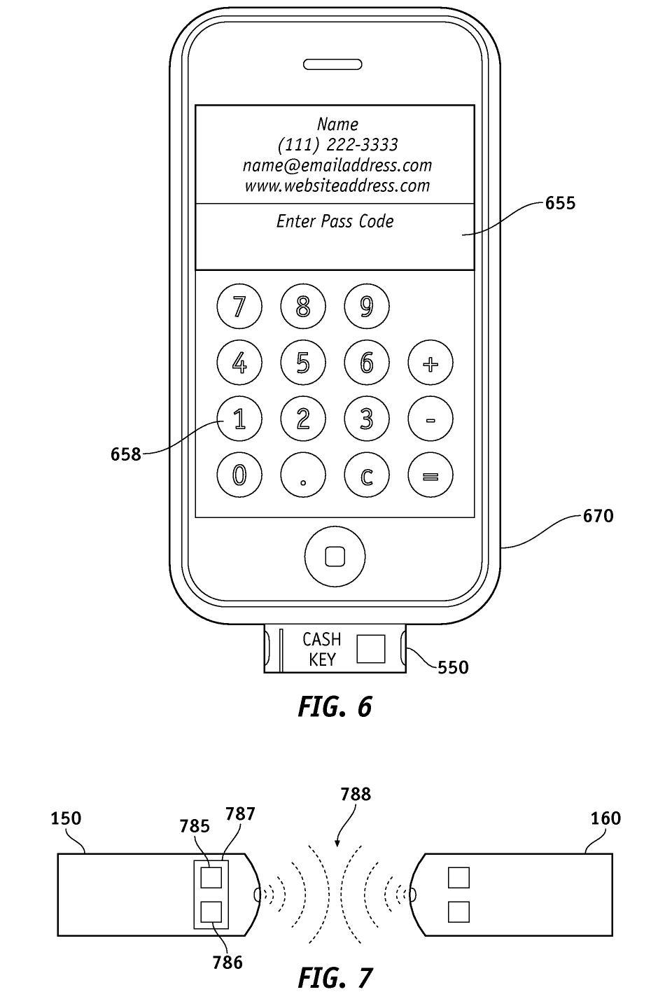

In still yet another embodiment, at least a portion of internal circuitry 457 may comprise various memory components, such as RAM, ROM, DRAM, DDR, SDRAM, Cache, flash, and the like memory. First device 150 may further comprise internal circuitry 457 that allows device 150 to be adaptable to other electronic devices to utilize their systems. For example, device 150 may lack an output mechanism, such as display 455, but may benefit from the output mechanism of other devices, such as, a cell phone, an IPOD®, an IPHONE®, a mp3 player, a PDA, a BlackBerry®, and the like. For example, with reference to FIG. 5, device 550 comprises may comprise an input mechanism 556, which may be a biometric security element, similar to biometric security element 456 of device 150. Device 550 further comprises a second input mechanism 557, wherein input mechanism 557 comprises a magnetic card reader 557. Device 550 also comprises electronic connection element 551 and may be similar to electronic connection element 351 of device 150, but electronic connection element 551, in this embodiment, may be suitably configured to couple to an IPHONE®. In this manner, device 550 may use the particular elements from the IPHONE®. FIG. 6 shows device 550 coupled to an IPHONE® 670. In this manner, user 115 can realize the benefit of the functions of IPHONE® 670, such as display 655, touch screen 658, and/or any other functions IPHONE® 670 may provide. Moreover, IPHONE® 670 may further operate as a terminal, similar to terminal 140 or 145 described above.

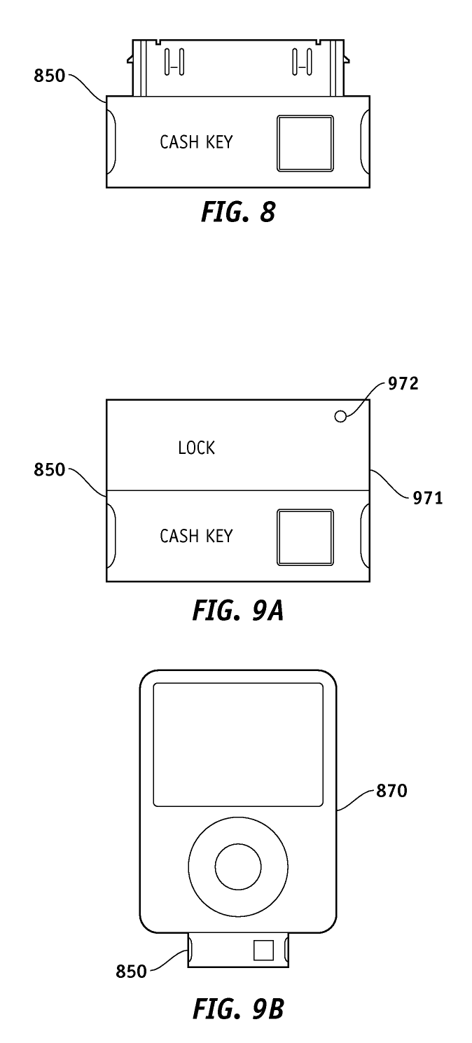

With momentary reference to FIGS. 8 and 9, device 850 may be similar to device 550, but lacking a magnetic card reader. FIG. 9 shows device 850 coupled to an IPOD® 870, and similar to how device 550 couples to IPHONE® 670 to benefit from the functions of IPHONE® 670, device 850 can likewise benefit from the functions of IPOD® 870. FIG. 9 further shows device 850 comprising a lock cap 971 to protect the electronic connection (not shown) of device 850, and lock cap 971 may also comprise electronic circuitry to carry out various functions. In an embodiment, lock cap 971 comprises an indicator light 972 to provide feedback and/or notification to a user.

Internal circuitry, such as internal circuitry 457 of device 150, may further comprise a receiver and/or a transmitter. Such receiver or transmitter may be used to conduct a monetary exchange and transfer. For example, with reference to FIG. 7, device 150 may comprise a receiver 785 and a transmitter 786 as components of a communication system 787. Receiver 785 and transmitter 786 may be configured to relay a signal, for example signal 788. In an embodiment, when device 150 is placed in close proximity to another device, such as device 160 that comprises a similar communication system, users of devices 150 and 160 may carry out the various fund transaction procedures. Signal 788 may comprise RF signals comprising a particular frequency, strength, bandwidth, wave-type, and the like. Signal 788 may also comprise infrared, overlapped, embedded, and/or encrypted, and the like signals.

Among various embodiments, a communication system, such as communication system 787, may comprise near field communication systems, non-near field communication systems, coupled or hard wired communication systems, dish-satellite communication systems, cell tower communication systems, and the like. In an embodiment, near field communications may comprise a relatively close distance between two devices brought together, and based upon the configuration of the transmitter and/or receiver for each device, the near field communication may comprise a few inches, a few feet, a few yards, etc. In an embodiment, near field communications may comprise a simplex, one way near field communication, or a duplex two way near field communication. In sum, any communication system may be used to carry out the various methods, procedures, and functions of monetary exchange and transfer. Among the various embodiments and/or devices, communications may be conducted between or among user devices, merchants, banks, ATMs, as well as other suitably enabled devices, such as, and mentioned briefly above, cell phones, IPODs®, IPHONES®, PDAs, BlackBerrys®, mp3 players, and the like.

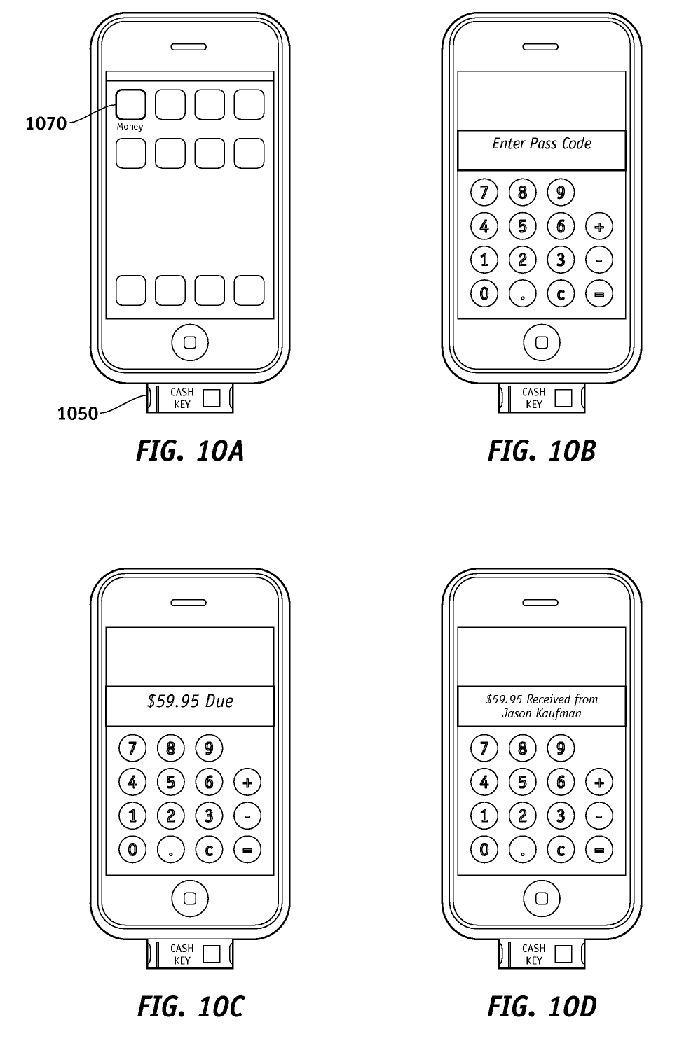

Among the various embodiments, devices may comprise software of accounting systems to maintain and manage the available funds and transactions that occur among devices. The accounting system may comprise an accounting of available funds, funds transferred, funds received, balances, transaction histories, spending habits, authorized users, contacts, authorized devices, and the like. With momentary reference to FIG. 10, a device 1050 may be coupled to an IPHONE® 1070 to function as described earlier with respect to device 550 coupled to IPHONE® 670. In this embodiment, a user may operate the touch screen of IPHONE® 1070 to enter a password to unlock the devices and/or functions of device 1050 and/or IPHONE® 1070. This embodiment further shows that the display of IPHONE® 1070 can prompt a user to show that a particular sum is due, or the display of IPHONE® 1070 can further show/confirm that a payment has been received. This is merely an example of one embodiment, and device 1050 alone or in combination with another device, such as IPHONE® 1070 may be configured to carry out other functions.

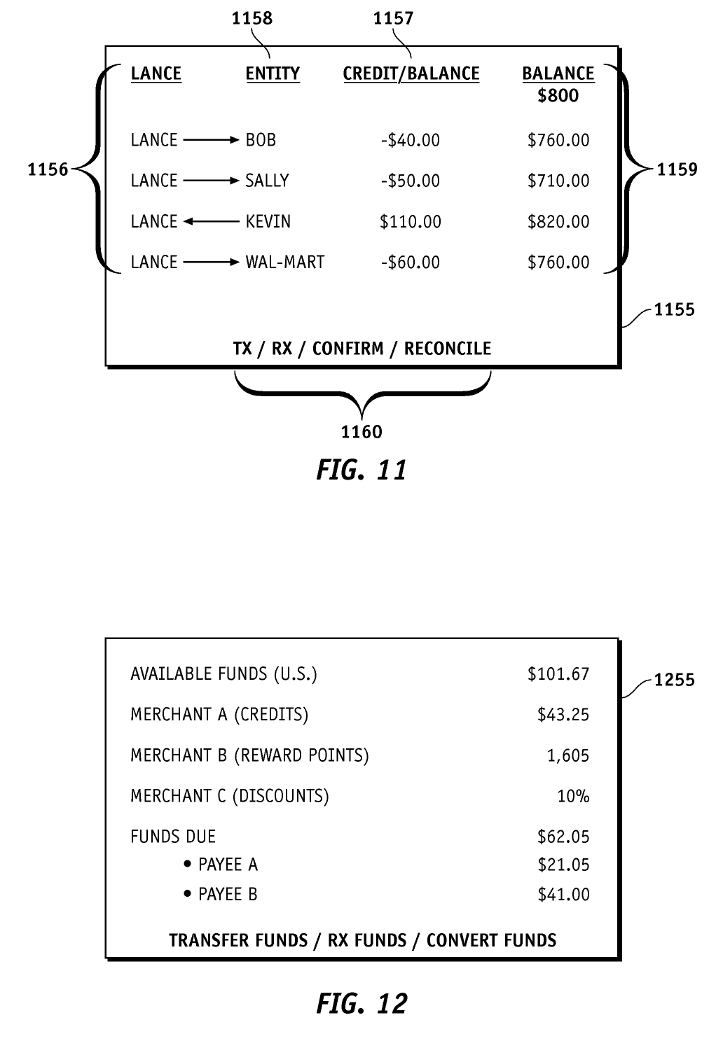

As mentioned briefly above, a device may comprise software to carry out various accounting procedures. An embodiment of an accounting system may provide various readable accounts, visual graphics, such as bar graphs, pie charts, line graphs, and the like. Another embodiment of accounting system may be configured to manage a single account or multiple accounts of similar or varying types. The accounting may be automatic, for example, after each transaction, or at predetermined intervals, such as daily, hourly, weekly, or the accounting may occur when prompted by a user, etc. In some embodiments, the accounting may occur in real time. In an embodiment, the accounting software may notify the user if there are sufficient funds available for a particular transfer. In another embodiment, the accounting may notify a user that additional funds are needed for a given transaction, and based upon the configuration of the device and/or users account, may promptly extend credit or communicate with the central location to acquire additional funds. With reference to FIG. 11, an example of an accounting is shown. A display 1155 may depict a ledger 1156 of recent transactions. Display 1155 may also show funds 1157 transferred and received by the user. In this example, the transfers and receptions are indicated as debits and credits. Display 1155 may also display various entities 1158 and a rolling balance 1159. Display 1155, in an embodiment, may also display other functions available to the user, such as functions 1160 for transferring, receiving, confirmation and reconciliation. The above embodiments are merely examples, and other embodiments are contemplated by this disclosure.

Funds may comprise currency (foreign or domestic), points, credits, and any other like units. Among the various embodiments, funds may comprise various forms in any one or plurality of manners. For example, the device may generally store an accounting of funds as currency, such as dollars and cents. The device may also comprise a combination of available funds for transfer and exchange. In an embodiment, the device may comprise available funds and/or funds earmarked for specific payees. In addition, the device may also comprise not only available funds, but funds due to the device holder. In yet another embodiment, the device may comprise funds, such as currency, but may also comprise credits, debits, points, rewards, incentives, and the like. In an embodiment, a device comprises currency, credits from a first merchant, rewards due from a second merchant, and/or a percentage off purchases from a third merchant etc. In still yet another embodiment, the device may also be configured to convert all or a portion of funds from one type of currency to another type of currency, such as a foreign currency. With reference to FIG. 12, a display 1255 shows an embodiment of various funds that a device may have available or that may be due to it.

In another embodiment, a device may be configured to be a one way transfer or receiving device. For example, because of credit or other restrictions, the device may be enabled to only receive funds or only transfer funds. In still another embodiment, the device may be restricted and enabled to transfer and/or receive funds from only designated entities. For example, the device may be used by a minor or employee, wherein the device may be restricted by a guardian or employer. The restrictions may be limited to only a certain amount of funds available for transfer, or the restrictions may be limited to a certain amount of funds available for transfer within a given period of time, or the restrictions may be limited to transfers only to certain payees, such as a school, particular stores at a mall, gas stations, a grocery store, and the like. In still yet another embodiment, the device may be configured to take advantage of automatic savings plans or other incentive plans offered by the user's financial entity.

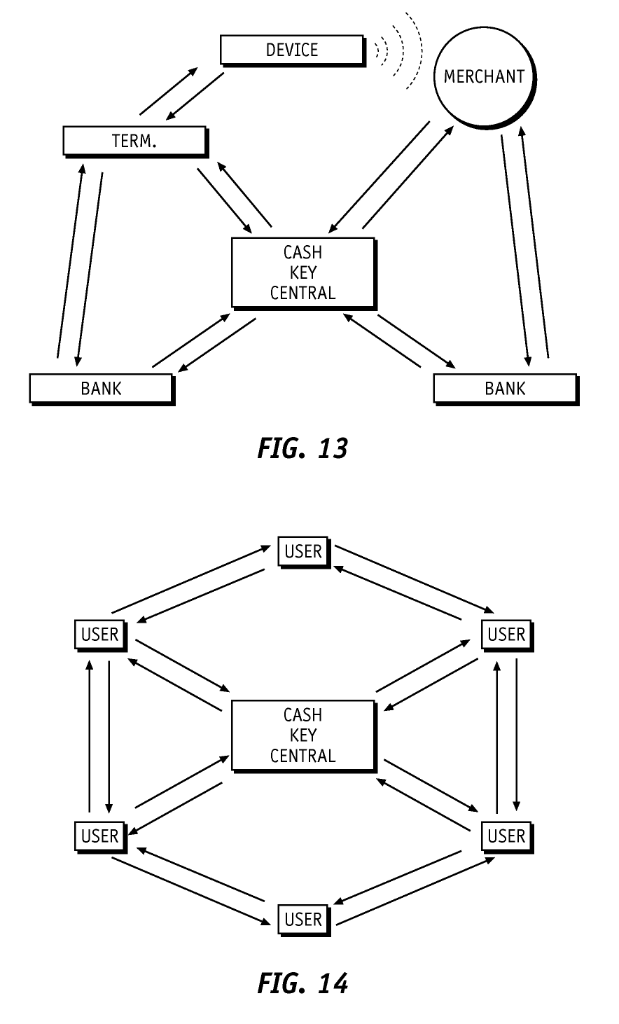

With reference to FIGS. 13 and 14, in other embodiments of monetary transfer systems, instead of a transfer between two users, an exemplary transfer may occur between a user device and a merchant (FIG. 13) and/or between a Cash Key Central and a plurality of users (FIG. 14).

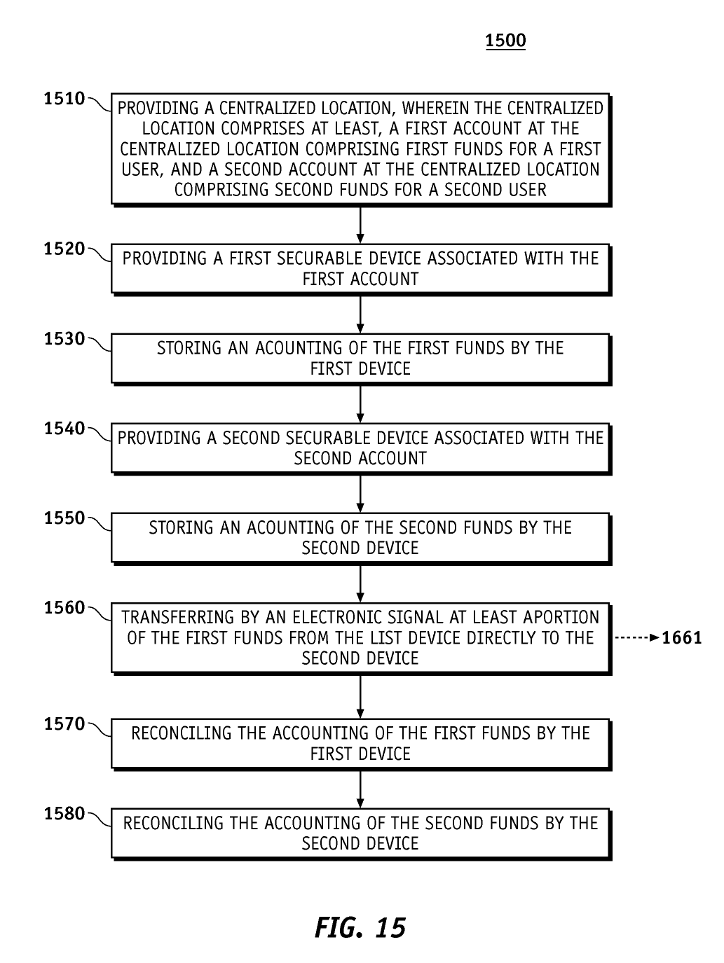

Turning now to a method to transfer and exchange funds and with reference to FIG. 15, a method 1500 comprises providing a centralized location, wherein the centralized location comprises at least a first account at the centralized location comprising first funds for a first user, and a second account at the centralized location comprising second funds for a second user (1510); providing a first securable device associated with the first account (1520); storing an accounting of the first funds by the first device (1530); providing a second securable device associated with the second account (1540); storing an accounting of the second funds by the second device (1550); transferring by an electronic signal at least a portion of the first funds from the first device directly to the second device (1560); reconciling the accounting of the first funds by the first device (1570); and reconciling the accounting of the second funds by the second device (1580).

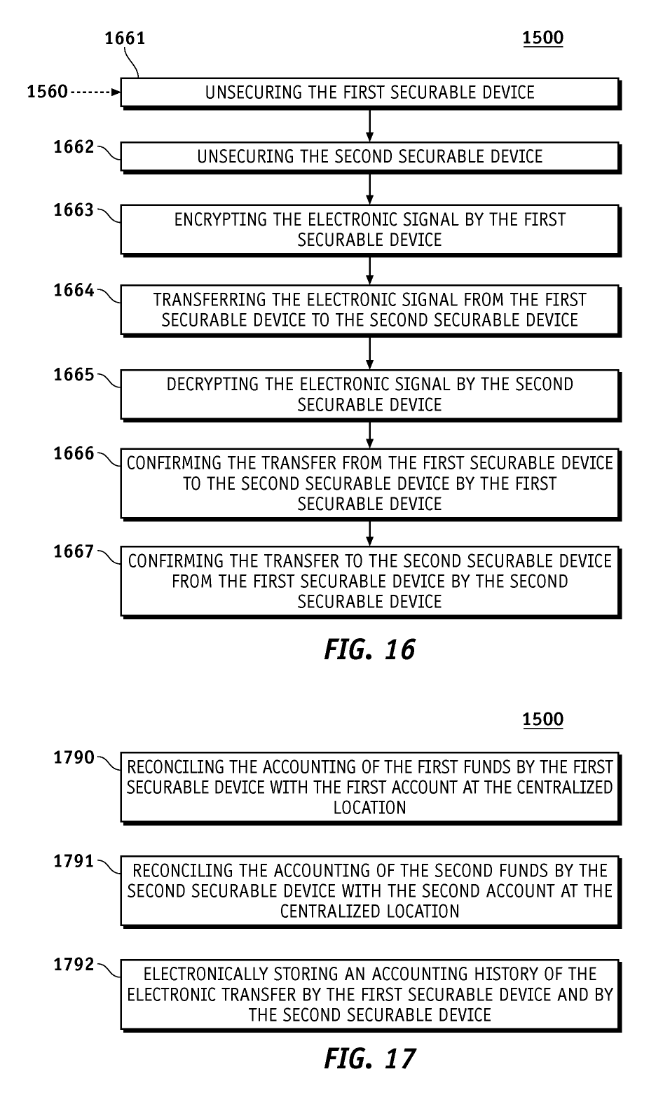

Referring to FIG. 16, the method 1500 may further comprise transferring by an electronic signal at least a portion of the first funds from the first device directly to the second device may comprise (1560); unsecuring the first securable device (1661); unsecuring the second securable device (1662); encrypting the electronic signal by the first securable device (1663); transferring the electronic signal from the first securable device to the second securable device (1664); decrypting the electronic signal by the second securable device (1665); confirming the transfer from the first securable device to the second securable device by the first securable device (1666); and confirming the transfer to the second securable device from the first securable device by the second securable device (1667).

Referring to FIG. 17, a method to transfer and exchange funds 1500 according to various aspects of the present invention may further comprise reconciling the accounting of the first funds by the first securable device with the first account at the centralized location (1790); reconciling the accounting of the second funds by the second securable device with the second account at the centralized location (1791); and electronically storing an accounting history of the electronic transfer by the first securable device and by the second securable device (1792).

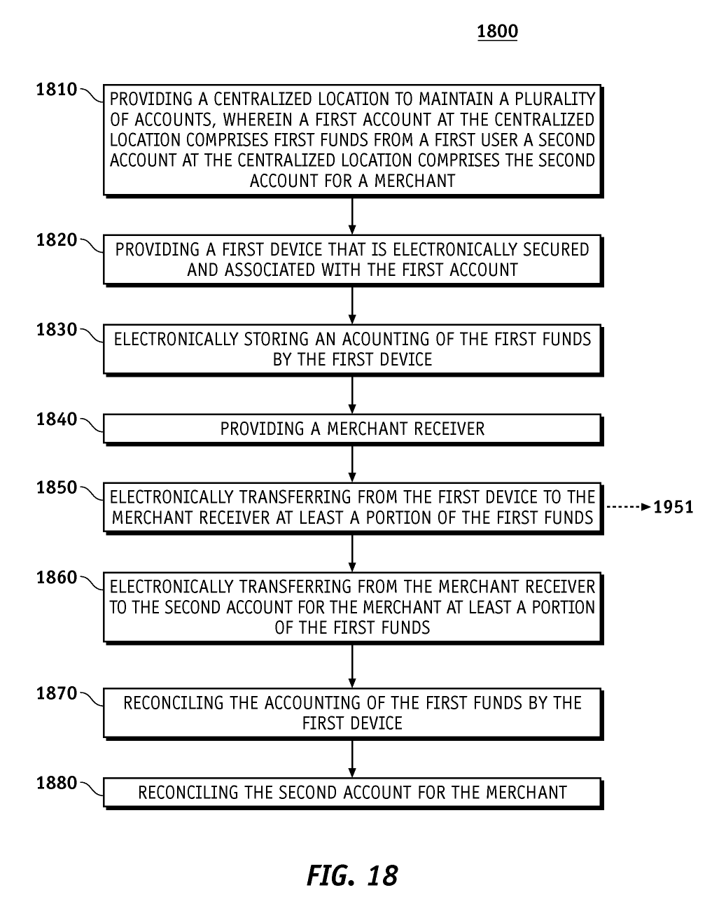

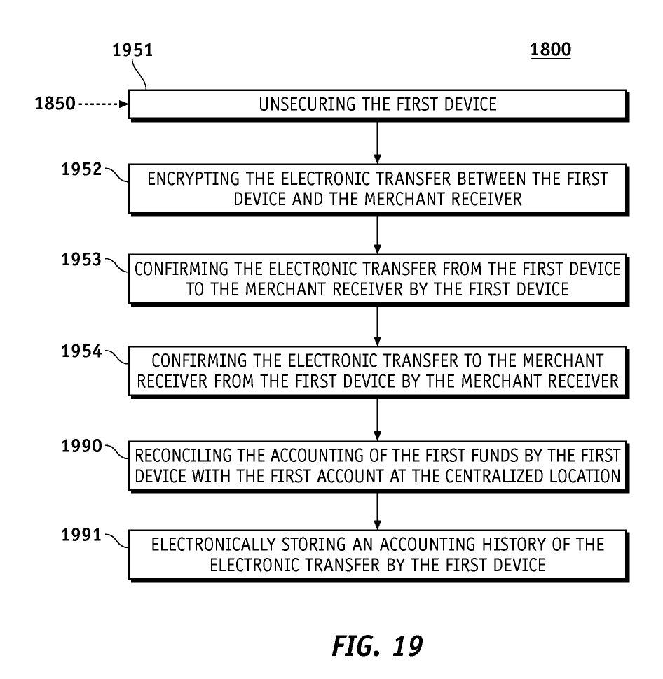

Referring to FIG. 18, in another embodiment, a method for transferring and exchanging funds 1800 may comprise providing a centralized location to maintain a plurality of accounts, wherein a first account at the centralized location comprises first funds from a first user a second account at the centralized location comprises the second account for a merchant (1810); providing a first device that may be electronically secured and associated with the first account (1820); electronically storing an accounting of the first funds by the first device (1830); providing a merchant receiver (1840); electronically transferring directly from the first device to the merchant receiver at least a portion of the first funds (1850); electronically transferring from the merchant receiver to the second account for the merchant the at least a portion of the first funds (1860); reconciling the accounting of the first funds by the first device (1870); and reconciling the second account for the merchant (1880).

The method for transferring and exchanging funds 1800 may further comprise electronically transferring directly from the first device to the merchant receiver at least a portion of the first funds (1850); unsecuring the first device (1951); encrypting the electronic transfer between the first device and the merchant receiver (1952); confirming the electronic transfer from the first device to the merchant receiver by the first device (1953); and confirming the electronic transfer to the merchant receiver from the first device by the merchant receiver (1954).

The method for transferring and exchanging funds 1800 may further comprise reconciling the accounting of the first funds by the first device with the first account at the centralized location (1990); and electronically storing an accounting history of the electronic transfer by the first device (1991).

The steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims. The various components disclosed in conjunction with the method may be similar to the elements described throughout this disclosure with respect to the system.

In the foregoing specification, the methods and systems for monetary exchange and transfer have been described with reference to specific embodiments. Various modifications and changes may be made, however, without departing from the scope of the methods and systems for monetary exchange and transfer as may be set forth in the claims. The specification and figures are illustrative, rather than restrictive, and modifications are intended to be included within the scope of the methods and systems for monetary exchange and transfer. Accordingly, the scope of the methods and systems for monetary exchange and transfer should be determined by the claims and their legal equivalents rather than by merely the examples described.

Benefits, other advantages and solutions to problems have been described with regard to particular embodiments; however, any benefit, advantage, solution to problem or any element that may cause any particular benefit, advantage or solution to occur or to become more pronounced are not to be construed as critical, required or essential features or components of any or all the claims in any issuing patent.

The terms “comprise”, “comprises”, “comprising”, “having”, “including”, “includes” and the like refer to a non-exclusive inclusion, such that a process, method, system, article, composition or apparatus that comprises a list of elements does not include only those elements recited, but may also include other elements not expressly listed or inherent to such process, method, system, article, composition or apparatus. Other combinations and/or modifications of the structures, arrangements, applications, proportions, elements, materials or components used in the practice of the methods and systems for monetary exchange and transfer, in addition to those not specifically recited, may be varied or otherwise particularly adapted to specific environments, manufacturing specifications, design parameters or other operating requirements without departing from the general principles of the same.

1. A transaction system comprising:
a centralized location, wherein the centralized location comprises at least:
a first account at the centralized location comprising first funds for a first user;
a second account at the centralized location comprising second funds for a second user;
a first device associated with the first account configured to electronically store a first accounting by the first device;
a second device associated with the second account configured to electronically store a second accounting by the second device;
an electronic transfer system configured to transfer at least a portion of the first funds from the first device directly to the second device;
a receiver system configured to receive at least a portion of the first funds by the second device directly from the first device;
a first device accounting reconciliation system configured to reconcile the accounting of the first funds by the first device; and
a second device accounting reconciliation system configured to reconcile the accounting of the second funds by the second device.

2. The system of claim 1, wherein the first device comprises a secured first key fob and the second device comprises a secured second key fob.

3. The system of claim 2, wherein the secured first key fob comprises a biometrically secured first key fob, and the secured second key fob comprises a biometrically secured second key fob.

4. The system of claim 1, wherein the first device and the second device comprise internal memory.

5. The system of claim 1, wherein the first device and the second device comprise display systems.

6. The system of claim 1, wherein the first device and the second device comprise near field communication systems.

7. A transaction method comprising:
providing a centralized location;
wherein the centralized location comprises at least,
a first account at the centralized location comprising first funds for a first user;
a second account at the centralized location comprising second funds for a second user;
providing a first securable device associated with the first account;
storing an accounting of the first funds by the first device;
providing a second securable device associated with the second account;
storing an accounting of the second funds by the second device;
transferring by an electronic signal at least a portion of the first funds from the first device directly to the second device;
reconciling the accounting of the first funds by the first device; and
reconciling the accounting of the second funds by the second device.

8. The transaction method of claim 7, wherein:
providing the first securable device comprises providing the first securable device to be a first securable key fob; and
providing the second securable device comprises providing the second securable device to be a second securable key fob.

9. The transaction method of claim 8, wherein:
providing the first securable key FOB comprises providing the first securable key FOB to be biometrically securable; and
providing the second securable key FOB comprises providing the second securable key FOB to be biometrically securable.

10. The transaction method of claim 7, wherein transferring by an electronic signal at least a portion of the first funds from the first securable device directly to the second securable device further comprises:
unsecuring the first securable device;
unsecuring the second securable device;
encrypting the electronic signal by the first securable device;
transferring the electronic signal from the first securable device to the second securable device;
decrypting the electronic signal by the second securable device;
confirming the transfer from the first securable device to the second securable device by the first securable device; and
confirming the transfer to the second securable device from the first securable device by the second securable device.

11. The transaction method of claim 10, further comprising:
reconciling the accounting of the first funds by the first securable device with the first account at the centralized location; and
reconciling the accounting of the second funds by the second securable device with the second account at the centralized location.

12. The transaction method of claim 11, further comprising electronically storing an accounting history of the electronic transfer by the first securable device and by the second securable device.

13. The transaction method of claim 7, wherein at least a portion of the first funds for the first account originate from at least one of a bank account, a checking account, a savings account, cash, a credit card, a debit card, a rewards card, a merchant card, and an incentive program.

14. A transaction method comprising:
providing a centralized location to maintain a plurality of accounts, wherein:
a first account at the centralized location comprises first funds from a first user;
a second account at the centralized location comprises the second account for a merchant;
providing a first device that may be electronically secured and associated with the first account;
electronically storing an accounting of the first funds by the first device;
providing a merchant receiver;
electronically transferring directly from the first device to the merchant receiver at least a portion of the first funds;
electronically transferring from the merchant receiver to the second account for the merchant the at least a portion of the first funds;
reconciling the accounting of the first funds by the first device; and
reconciling the second account for the merchant.

15. The transaction method of claim 14, wherein providing the first device comprises providing the first device to be a first secured key fob.

16. The transaction method of claim 15, wherein providing the first secured key fob comprises providing the first secured key fob to be biometrically secured.

17. The transaction method of claim 14, wherein transferring at least a portion of the first funds from the first device to the merchant receiver further comprises:
unsecuring the first device;
encrypting the electronic transfer between the first device and the merchant receiver;
confirming the electronic transfer from the first device to the merchant receiver by the first device; and
confirming the electronic transfer to the merchant receiver from the first device by the merchant receiver.

18. The transaction method of claim 17, further comprising reconciling the accounting of the first funds by the first device with the first account at the centralized location.

19. The transaction method of claim 18, further comprising electronically storing an accounting history of the electronic transfer by the first device.

20. The transaction method of claim 14, wherein at least a portion of the first funds for the first account are provided by at least one of a bank account, a checking account, a savings account, cash, a credit card, a debit card, a rewards card, a merchant card, and an incentive program.
